(19) United States
(12) Patent Application Publication
(10) Pub. No.: US 2026/0313482 A1
(43) Pub. Date: Oct. 8, 2026

(54) METHOD, DEVICE AND COMPUTER STORAGE MEDIUM OF COMMUNICATION

(71) Applicant: NEC Corporation, Tokyo (JP)

(72) Inventors: Da WANG, Beijing (CN); Gang WANG, Beijing (CN)

(73) Assignee: NEC Corporation, Tokyo (JP)

(21) Appl. No.: 18/998,609

(22) PCT Filed: Jul. 28, 2022
(86) PCT No.: PCT/CN2022/108738

§ 371 Date: Jan. 27, 2025

(51) Int. Cl. H04W 36/00

(52) U.S. Cl. CPC H04W 36/0069; H04W 36/0058

(57) ABSTRACT

Embodiments of the present disclosure relate to methods, devices and computer readable media of communication. A terminal device receives, from a first network device, information indicating a path switch for an application layer measurement report; and transmits, based on the information, the application layer measurement report to the first network device directly or via a second network device. In this way, an application layer measurement in NR-DC may be well supported.

### TECHNICAL FIELD

Embodiments of the present disclosure generally relate to the field of telecommunication, and in particular, to methods, devices and computer storage media of communication for an application layer measurement in new radio-dual connectivity (NR-DC) scenarios.

### BACKGROUND

An application layer measurement collection function enables collection of application layer measurements from a terminal device. Currently, it is expected to support for an application layer measurement in NR-DC, e.g., enable an application layer measurement reporting over a master node (MN)/a secondary node (SN) for NR-DC architecture and maintain continuity of the application layer measurement reporting. However, a mechanism of an application layer measurement in NR-DC is still incomplete and needs to be further developed.

### SUMMARY

In general, embodiments of the present disclosure provide methods, devices and computer storage media of communication for an application layer measurement in NR-DC.

In a first aspect, there is provided a method of communication. The method comprises: receiving, at a terminal device and from a first network device, information indicating a path switch for an application layer measurement report; and transmitting, based on the information, the application layer measurement report to the first network device directly or via a second network device.

In a second aspect, there is provided a method of communication. The method comprises: transmitting, at a first network device and to a terminal device, information indicating a path switch for an application layer measurement report; and receiving, from the terminal device, the application layer measurement report directly or via a second network device.

In a third aspect, there is provided a method of communication. The method comprises: receiving, at a second network device and from a terminal device, an application layer measurement report; and transmitting the application layer measurement report to a first network device.

In a fourth aspect, there is provided a device of communication. The device comprises a processor configured to cause the device to perform the method according to any of the first to third aspects of the present disclosure.

In a fifth aspect, there is provided a computer readable medium having instructions stored thereon. The instructions, when executed on at least one processor, cause the at least one processor to perform the method according to any of the first to third aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates a schematic diagram illustrating a process of communication for an application layer measurement in NR-DC according to embodiments of the present disclosure;

FIG. 3A illustrates a schematic diagram illustrating a process of communication for a signaling based application layer measurement according to embodiments of the present disclosure;

FIG. 3B illustrates a schematic diagram illustrating a process of communication for a management based application layer measurement according to embodiments of the present disclosure;

FIG. 3C illustrates a schematic diagram illustrating another process of communication for a signaling based application layer measurement according to embodiments of the present disclosure;

FIG. 3D illustrates a schematic diagram illustrating another process of communication for a management based application layer measurement according to embodiments of the present disclosure;

FIG. 3E illustrates a schematic diagram illustrating another process of communication for a management based application layer measurement according to embodiments of the present disclosure;

FIG. 4 illustrates a schematic diagram illustrating a process of communication for an application layer measurement configuration in mobility scenarios according to embodiments of the present disclosure;

FIG. 5 illustrates an example method of communication implemented at a terminal device in accordance with some embodiments of the present disclosure;

FIG. 6 illustrates an example method of communication implemented at a first network device in accordance with some embodiments of the present disclosure;

FIG. 7 illustrates an example method of communication implemented at a second network device in accordance with some embodiments of the present disclosure; and

FIG. 8 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IOT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “packet duplication” may be interchangeably used with “packet data convergence protocol (PDCP) duplication” or “PDCP packet duplication”.

In the context of the present disclosure, the term “application layer measurement information” may refer to at least one of the following:
regular application layer measurement information comprising at least one of the following:
   an application layer measurement reference;
   a service type;
   an area scope of application layer measurement collection;
   measurement collection entity Internet protocol address;
   application layer measurement status;
   a container for application layer measurement configuration;
   slice support list for application layer measurement collection; or
   minimization of drive tests (MDT) alignment information, or
radio access network (RAN) visible application layer measurement information comprising at least one of the following:
   available RAN visible application layer measurement metrics, including whether a buffer level can be collected and whether a playout delay can be collected.

In the context of the present disclosure, the term “application layer measurement configuration” may refer to at least one of the following:
regular application layer measurement configuration comprising at least one of the following:
   an identity (ID) of an application layer measurement configuration;
   a configuration of application layer measurements carried in a container;
   a service type;
   an indication indicating whether a terminal device shall transmit indications when sessions in the application layer start and stop, or
RAN visible application layer measurement configuration comprising at least one of the following:
   periodicity of ran visible reporting;
   maximum number of buffer level entries that can be reported for RAN visible application layer measurement; or
   an indication on whether a terminal device shall report initial playout delay for RAN visible application layer measurement.

In the context of the present disclosure, the term “application layer measurement report” may refer to at least one of the following:
an ID of an application layer measurement configuration;
regular application layer measurement results comprising at least one of the following:
   application layer measurements carried in a container; or
   an indication of an application layer measurement session in an application layer starts or stops; or
RAN visible application layer measurement results comprising at least one of the following:
   application layer buffer level;
   application layer initial playout delay; or
   List of identities of protocol data unit (PDU) sessions.

As mentioned above, it is expected to support for an application layer measurement in NR-DC, e.g., enable an application layer measurement reporting via SN. It is expected to specify an application layer measurement configuration and measurement reporting over MN/SN for NR-DC architecture, and specify an application layer measurement reporting over the other DC leg in order to maintain reporting continuity. Further, it is expected to support RAN-visible application layer measurement and radio related measurement configuration and reporting in NR-DC scenarios. It is also expected to specify application layer measurement continuity in mobility scenarios in NR-DC and specify alignment of an application layer measurement and a radio related measurement in NR-DC.

Embodiments of the present disclosure provide a solution of communication to support an application layer measurement in NR-DC scenarios. In the solution, a terminal device receives, from a first network device, information indicating a path switch for an application layer measurement report. Based on the information, the terminal device transmits the application layer measurement report to the first network device directly or via a second network device. In this way, an application layer measurement reporting may be continuous when a network is overloaded.

Principles and implementations of the present disclosure will be described in detail below with reference to the figures.

### EXAMPLE OF COMMUNICATION NETWORK

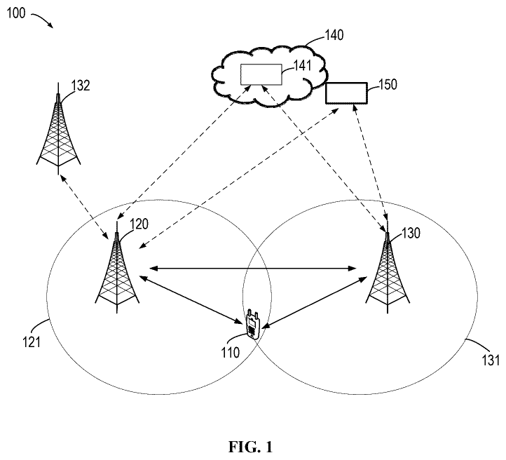

FIG. 1 illustrates a schematic diagram of an example communication network 100 in which some embodiments of the present disclosure can be implemented. As shown in FIG. 1, the communication network 100 may include a terminal device 110 and network devices 120 and 130. The network device 120 may provide a group of cells (for convenience, only one cell 121 is shown) to serve one or more terminal devices. The network device 130 may also provide a group of cells (for convenience, only one cell 131 is shown) to serve one or more terminal devices. For convenience, the term “a group of cells” may be interchangeably used with “a cell group”.

In some embodiments, the terminal device 110 may be located in the cell 121 and served by the network device 120. In some embodiments, the terminal device 120 may be located in the cell 131 and served by the network device 130. In some embodiments, the terminal device 110 may simultaneously establish a connection with the first network device 120 and a connection with the second network device 130. In this case, the first network device 120 may be a MN and the second network device 130 may be a SN. Alternatively, the first network device 120 may be a SN and the second network device 130 may be a MN. For illustration, the following description will be given in connection with the first network device 120 serving as a MN and the second network device 130 serving as a SN. A cell group provided by a MN is called as master cell group (MCG), and a cell group provided by a SN is called as a secondary cell group (SCG).

The communication network 100 may further comprise a core network (CN) 140. The CN 140 may comprise a plurality of network devices having various functionalities. For illustration, only AMF 141 is shown. It is to be understood that the AMF 141 is merely an example, and any other suitable forms are also feasible. The communication network 100 may further comprise an operation administration and maintenance (OAM) 150.

The communication network 100 may further comprise a network device 132. In some embodiments where the network device 120 serves as a MN and the network device 130 serves as a SN, the MN of the terminal device 110 may be hand over from the network device 120 to the network device 132. In this case, the network device 120 may be called as a source MN, and the network device 132 may be called as a target MN.

It is to be understood that the number of devices and cells in FIG. 1 is given for the purpose of illustration without suggesting any limitations to the present disclosure. The communication network 100 may include any suitable number of network devices and/or terminal devices and/or cells adapted for implementing implementations of the present disclosure.

In some embodiments, a terminal device (for example, the terminal device 110) and a network device (for example, the network device 120 or 130) may communicate with each other via a channel such as a wireless communication channel on an air interface (e.g., Uu interface). The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible.

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In some embodiments, the terminal device 110 may perform a signaling based application layer measurement. In this case, an operation administration and maintenance (OAM) function (not shown) may initiate activation of an application layer measurement for a specific terminal device via a core network (CN) (not shown), and a network device (e.g., the network device 120) may receive one or more application layer measurement configurations by means of a terminal device-associated signaling. The application layer measurement configuration for signaling based activation may comprise an application layer measurement configuration list and the corresponding information for an application layer measurement collection, e.g., application layer measurement reference, service type, measurement collection entity (MCE) Internet protocol (IP) address, slice scope, area scope, minimization of drive tests (MDT) alignment information and an indication of available radio access network (RAN) visible QoE metrics.

In some embodiments, the terminal device 110 may perform a management based application layer measurement. In this case, the OAM function may send one or more application layer measurement configurations directly to a network device (e.g., the network device 120). An application layer measurement configuration for management based activation may also comprise an application layer measurement configuration list and the corresponding information for application layer measurement collection. Each application layer measurement configuration is encapsulated in a transparent container and is transmitted to the terminal device 110. The network device 120 may select terminal device(s) that meet the required application layer measurement capability, area scope and slice scope.

In some embodiments, radio-related measurements may be collected via immediate MDT for all types of supported services for the purpose of QoE analysis. The MCE/trace collection entity (TCE) performs correlation of immediate MDT results and application layer measurement results collected at the same terminal device. Alignment between a signaling based application layer measurement and a signaling based MDT measurement may be supported. In this case, the signaling based application layer measurement configuration sent to the network device 120 may comprise the NG-RAN Trace identity (ID) of a signaling based MDT measurement. Alignment between a management based application layer measurement and a management based MDT measurement may be supported.

In some embodiments, the terminal device 110 and the network device 120 may communicate via a direct SRB between the terminal device 110 and the network device 120. In some embodiments, the terminal device 110 and the network device 130 may communicate via a direct SRB between the terminal device 110 and the network device 130.

A split SRB is a SRB between network devices with RLC bearers both in MCG and SCG. In some embodiments, the terminal device 110 and the network device 120 may communicate via a split SRB comprising one or more legs between the terminal device 110 and the network device 120 and another one or more legs between the terminal device 110 and the network device 120 via the network device 130. One of the legs may be set as a primary path. In some embodiments where packet duplication is configured for the terminal device 110, a PDCP packet from a PDCP entity of the terminal device 110 may be repeatedly transmitted via the legs to the network device 120.

Currently, it is still unclear how to perform an application layer measurement reporting over the other leg when overload on one leg occurs. It is also still unclear how to configure signaling based and management based allocation layer managements and how to achieve application layer measurement continuity in mobility scenarios in NR-DC.

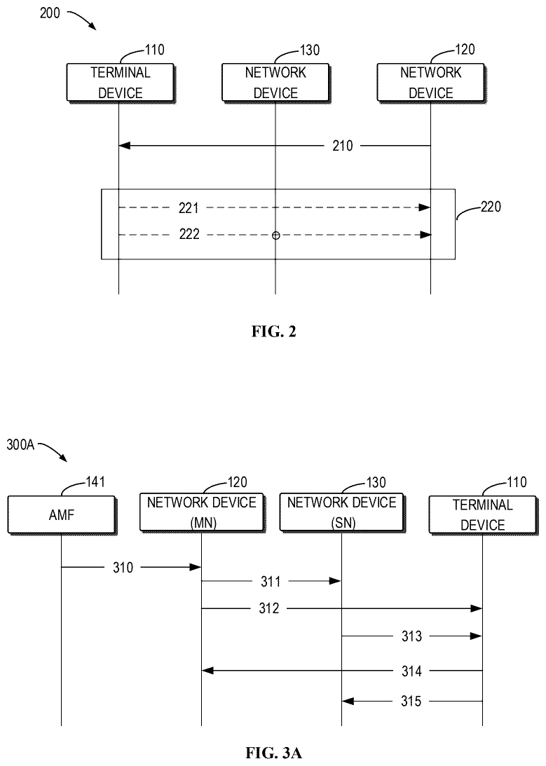

Embodiments of the present disclosure provide a solution of communication for an application layer measurement so as to overcome the above and other potential issues. For illustration, more details of the solution will be described with reference to FIG. 2.

### EXAMPLE IMPLEMENTATION OF APPLICATION LAYER MEASUREMENT REPORTING

FIG. 2 illustrates a schematic diagram illustrating a process 200 of communication for an application layer measurement reporting according to embodiments of the present disclosure. For the purpose of discussion, the process 200 will be described with reference to FIG. 1. The process 200 may involve the terminal device 110 and the network devices 120 and 130 as illustrated in FIG. 1. It is assumed that the terminal device 110 establishes a simultaneous connection with the network devices 120 and 130.

As shown in FIG. 2, a first network device (e.g., the network device 120) transmits 210, to the terminal device 110, information indicating a path switch for an application layer measurement report. The application layer measurement report is to be transmitted from the terminal device 110 to the network device 120. In some embodiments, the network device 120 may be a MN and network device 130 may be a SN. In some embodiments, the network device 120 may be a SN, and network device may be a SN.

Based on the information, the terminal device 110 transmits 220 the application layer measurement report to the network device 120. In some embodiments, the terminal device 110 may transmit 221 the application layer measurement report to the network device 120 directly. In some embodiments, the terminal device 110 may transmit 222 the application layer measurement report to the network device 120 via a second network device (e.g., the network device 130).

### Triggering Condition of Path Switch

In some embodiments, the information indicating a path switch for an application layer measurement report may be an indication for pausing the application layer measurement report. The network device 120 may transmit an indication (for convenience, also referred to as a first indication herein) for pausing the application layer measurement report. For example, an IE pausReporting in a RRC reconfiguration message may be set to true. It is to be understood that any other suitable forms are also feasible. In these embodiments, the terminal device 110 may transmit the application layer measurement report to the network device 120 via a cell group associated with the network device 130.

In some embodiments, the information indicating a path switch for an application layer measurement report may be an indication for changing a primary path of one SRB to a cell group of the network device 130. The network device 120 may transmit an indication (for convenience, also referred to as a second indication herein) for changing a primary path of one SRB to a cell group of the network device 130. In some embodiments where the network device 120 is a MN, the primary path of the SRB received from a network is required to be changed to the cell group of a SN. In these embodiments, the terminal device 110 may also transmit the application layer measurement report to the network device 120 via a cell group associated with the network device 130.

In some embodiments, the information indicating a path switch for an application layer measurement report may be an indication for resuming the application layer measurement report. The network device 120 may transmit an indication (for convenience, also referred to as a fifth indication herein) for resuming the application layer measurement report. For example, the IE pausReporting may be set to false. It is to be understood that any other suitable forms are also feasible. In these embodiments, the terminal device 110 may transmit the application layer measurement report to the network device 120 via a cell group associated with the network device 120.

In some embodiments, the information indicating a path switch for an application layer measurement report may be an indication for changing a primary path of one SRB to a cell group of the network device 120. The network device 120 may transmit an indication (for convenience, also referred to as a sixth indication herein) for changing a primary path of one SRB to a cell group of the network device 120. In some embodiments where the network device 120 is a SN, the primary path of the SRB received from a network is required to be changed to the cell group of a SN. In these embodiments, the terminal device 110 may also transmit the application layer measurement report to the network device 120 via a cell group associated with the network device 120.

In this way, application layer measurement continuity in NR-DC scenarios may be ensued.

### Transmission via SN

In some embodiments where the application layer measurement report is transmitted to the network device 120 via a cell group associated with the network device 130, the terminal device 110 may transmit the application layer measurement report using a split SRB between the network device 120 and the terminal device 110.

In some embodiments, the split SRB may comprise a split SRB1. In some embodiments, the split SRB may comprise a split SRB4. For example, in case that the network device 120 is a MN and the network device 130 is a SN, the split SRB may be a split SRB4. In some embodiments, the split SRB may comprise a split SRB3. For example, in case that the network device 120 is a SN and the network device 130 is a MN, the split SRB may be a split SRB3. It is to be understood that the split SRB may be any suitable SRBs existing or to be developed in future. In some embodiments, to establish the split SRB, the network device 120 may need to indicate the network device 130 that resources for split SRBs are requested for SRB4, SRB3 or a SRB to be developed in future. In some embodiments, the split SRB may be the same as a SRB between the network device 120 and the terminal device 110 which is used for direct transmission of application layer measurement from the terminal device 110 to the network device 120. In some embodiments, the split SRB may be different from the SRB between the network device 120 and the terminal device 110 which is used for direct transmission of application layer measurement from the terminal device 110 to the network device 120.

In some embodiments, the terminal device 110 may transmit the application layer measurement report using a SRB between the network device 130 and the terminal device 110. In this case, upon reception of the application layer measurement report, the network device 130 may forward the application layer measurement report or RAN visible application layer measurement report to the network device 120 via Xn interface.

In some embodiments, the SRB between the network device 130 and the terminal device 110 may comprise a SRB3, a SRB4, or a SRB to be developed in future. For example, in case that the network device 120 is a MN and the network device 130 is a SN, the SRB between the network device 130 and the terminal device 110 may be a SRB3 or a SRB to be developed in future. In case that the network device 120 is a SN and the network device 130 is a MN, the SRB between the network device 130 and the terminal device 110 may be a SRB4.

In some embodiments, if the terminal device 110 is configured with a split SRB between the network device 120 and the terminal device 110 or a SRB between the network device 130 and the terminal device 110, the terminal device 110 may transmit the application layer measurement report to the network device 120 via the network device 130. In other words, upon reception of the information indicating the path switch, the terminal device 110 may determine if the terminal device 110 is configured with the split SRB or the SRB between the network device 130 and the terminal device 110. If the terminal device 110 is configured with the split SRB or the SRB between the network device 130 and the terminal device 110, the terminal device 110 may transmit the application layer measurement report via the network device 130.

In some embodiments, if the terminal device 110 is not configured with the split SRB and the SRB between the network device 130 and the terminal device 110, the terminal device 110 may suspend transmission of the application layer measurement report, and store the application layer measurement report. For example, the terminal device 110 may suspend transmission of application layer measurement report containers and store any previously or subsequently received application layer measurement report.

In some embodiments, the split SRB may have a higher priority than the SRB between the network device 130 and the terminal device 110. In some embodiments, upon reception of the information indicating the path switch, the terminal device 110 may determine if the terminal device 110 is configured with the split SRB. If the terminal device 110 is configured with the split SRB, the terminal device 110 may transmit the application layer measurement report via the split SRB. If the terminal device 110 is not configured with the split SRB, the terminal device 110 may determine whether the terminal device 110 is configured with the SRB between the network device 130 and the terminal device 110. If the terminal device 110 is configured with the SRB between the network device 130 and the terminal device 110, the terminal device 110 may transmit the application layer measurement report via the SRB between the network device 130 and the terminal device 110.

In some embodiments, if the application layer measurement report is transmitted via a leg corresponding to the network device 130 of the split SRB, the application layer measurement report may be transmitted by a MeasurementReportAppLayer message or ULDedicatedMessageSegment with embedded segments of MeasurementReportAppLayer. In some embodiments, if the application layer measurement report is transmitted by the SRB between the network device 130 and the terminal device 110, the application layer measurement report may be transmitted by MeasurementReportAppLayer message embedded in ULInformationTransferMRDC message. Alternatively, the application layer measurement report may be transmitted by ULDedicatedMessageSegment with embedded segments of MeasurementReportAppLayer and the ULDedicatedMessageSegment is embedded in ULInformationTransferMRDC message.

In this way, an application layer measurement reporting may be continuous when a network is overloaded.

### Packet Duplication Impact to Split SRB

In case of split SRB, a packet duplication related configuration may not consistent with a transmission direction of the application layer measurement report. For example, packet duplication may be activated. However, a terminal device may only report the application layer measurement report to one of network devices. In another example, packet duplication is not activated and the primary path is a network device. However, a terminal device only needs to report the application layer measurement report to the other network device. Since a PDCP entity is not aware of the content of the packet, it is not able to submit the packet to a correct RLC entity.

In some embodiments where the application layer measurement report is transmitted to the network device 120 via a cell group associated with the network device 130, the PDCP of the terminal device 110 may submit PDCP packet containing the application layer measurement report to the RLC entity associated with the cell group of network device 130. In some embodiments, RRC layer of the terminal device 110 may need to indicate the PDCP layer of the terminal device 110 to submit the PDCP packet containing the application layer report to the RLC entity associated with the cell group of network device 130.

In some embodiments, if packet duplication is configured or activated for a split SRB between the network device 120 and the terminal device 110, the terminal device 110 may submit, from a higher layer (e.g., RRC layer) to a lower layer (e.g., PDCP layer) of the terminal device 110, the application layer measurement report and an indication (for convenience, also referred to as a third indication herein) indicating that a packet corresponding to the application layer measurement report is submitted to only a RLC entity associated with a cell group of the network device 130.

For example, upon reception of the information indicating the path switch, the RRC layer of the terminal device 110 may submit a RRC message containing the application layer measurement report to the lower layer (PDCP), and indicate to the lower layer (PDCP) to only submit the corresponding packet/PDU to the RLC entity associated with the cell group of the network device 130. The PDCP entity of the terminal device 110 submits the PDCP packet to the RLC entity associated with the cell group of the network device 130 if the indication from RRC layer is received. Otherwise the PDCP entity of the terminal device 110 may submit the duplicated PDCP packets to RLC entities activated for PDCP duplication.

In some embodiments, if no packet duplication is configured or activated for the split SRB and the primary path is set to a cell group of the network device 120, the terminal device 110 may submit, from a higher layer (e.g., RRC layer) to a lower layer (e.g., PDCP layer) of the terminal device 110, the application layer measurement report and an indication (for convenience, also referred to as a fourth indication herein) indicating that the packet corresponding to the application layer measurement report is submitted to the RLC entity associated with a cell group of the network device 130.

For example, upon reception of the information indicating the path switch, the RRC layer of the terminal device 110 may submit a RRC message containing the application layer measurement report to the lower layer (PDCP), and indicate to the lower layer (PDCP) to forward the corresponding packet/PDU to the RLC entity associated with the cell group of the network device 130. The PDCP entity of the terminal device 110 may submit the PDCP packet to the RLC entity associated with the cell group of the network device 130 if the indication from RRC layer is received. Otherwise the terminal device 110 may submit the PDCP packet to primary RLC entity (i.e., RLC entity associated with the primary path).

In some alternative or additional embodiments, if no packet duplication is configured or activated for the split SRB and the primary path is set to a cell group of the network device 120, the terminal device 110 may change the primary path to the cell group of the network device 130.

In this way, a PDCP layer may be able to submit PDCP packets containing an application layer measurement report only to a RLC entity associated with a cell group of another network device.

### EXAMPLE IMPLEMENTATION OF APPLICATION LAYER MEASUREMENT CONFIGURATION

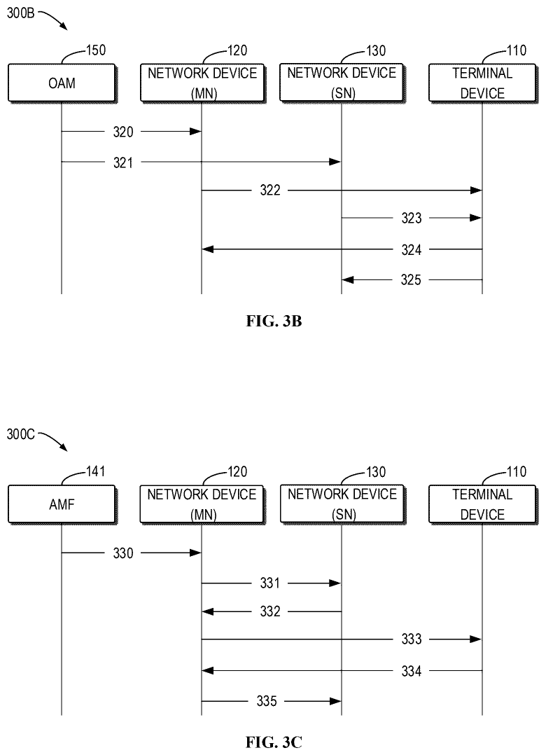

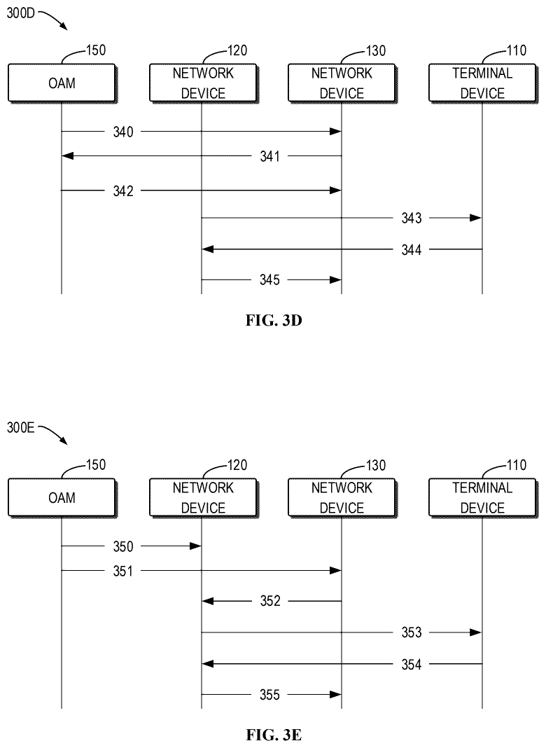

In some embodiments, independent application layer measurement configurations may be provided for a MN and a SN. In some embodiments, for a signaling based application layer measurement, application layer measurement information for MN and application layer measurement information for SN may be provided to a MN. The MN may forward, to the SN, the application layer measurement information for the SN. For illustration, an example process will be described with reference to FIG. 3A.

FIG. 3A illustrates a schematic diagram illustrating a process 300A of communication for a signaling based application layer measurement according to embodiments of the present disclosure. For the purpose of discussion, the process 300A will be described with reference to FIG. 1. The process 300A may involve the terminal device 110, the network devices 120 and 130 and the AMF 141 as illustrated in FIG. 1. It is assumed that the terminal device 110 establishes a simultaneous connection with the network devices 120 and 130. The network device 120 serves as a MN and the network device 130 serves as a SN.

As shown in FIG. 3A, the AMF 141 may transmit 310, to the network device 120 (i.e., MN), application layer measurement information for MN and application layer measurement information for SN.

The network device 120 may transmit 311, to the network device 130 (i.e., SN), the application layer measurement information for SN. In some embodiments, the network device 120 may forward the application layer measurement information for SN to the network device 130 via a SN addition request message, a SN modification request message or any other suitable messages.

The network device 120 may generate an application layer measurement configuration (for convenience, also referred to as a first configuration herein) from the application layer measurement information for MN and transmit 312 the first configuration to the terminal device 110.

The network device 130 may generate an application layer measurement configuration (for convenience, also referred to as a second configuration herein) from the application layer measurement information for SN and transmit 313 the second configuration to the terminal device 110.

The terminal device 110 may perform an application layer measurement for the network device 120 and transmit 314 an application layer measurement report (for convenience, also referred to as a first application layer measurement report herein) to the network device 120 based on the first configuration.

The terminal device 110 may perform an application layer measurement for the network device 130 and transmit 315 an application layer measurement report (for convenience, also referred to as a second application layer measurement report herein) to the network device 130 based on the second configuration.

In some embodiments, for a management based application layer measurement, application layer measurement information for MN and application layer measurement information for SN may be provided to a MN and a SN respectively. For illustration, an example process will be described with reference to FIG. 3B.

FIG. 3B illustrates a schematic diagram illustrating a process 300B of communication for a management based application layer measurement according to embodiments of the present disclosure. For the purpose of discussion, the process 300B will be described with reference to FIG. 1. The process 300B may involve the terminal device 110, the network devices 120 and 130 and the OAM 150 as illustrated in FIG. 1. It is assumed that the terminal device 110 establishes a simultaneous connection with the network devices 120 and 130. The network device 120 serves as a MN and the network device 130 serves as a SN.

As shown in FIG. 3B, the OAM 150 may transmit 320, to the network device 120 (i.e., MN), application layer measurement information for MN. The OAM 150 may transmit 321, to the network device 130 (i.e., SN), application layer measurement information for SN.

The network device 120 may generate an application layer measurement configuration (for convenience, also referred to as a first configuration herein) from the application layer measurement information for MN and transmit 322 the first configuration to the terminal device 110.

The network device 130 may generate an application layer measurement configuration (for convenience, also referred to as a second configuration herein) from the application layer measurement information for SN and transmit 323 the second configuration to the terminal device 110.

The terminal device 110 may perform an application layer measurement for the network device 120 and transmit 324 an application layer measurement report (for convenience, also referred to as a first application layer measurement report herein) to the network device 120 based on the first configuration.

The terminal device 110 may perform an application layer measurement for the network device 130 and transmit 325 an application layer measurement report (for convenience, also referred to as a second application layer measurement report herein) to the network device 130 based on the second configuration.

In some embodiments, for both MN and SN, a management based application layer measurement should not overwrite a signaling based application layer measurement.

In some embodiments, a single application layer measurement configuration may be provided for both MN and SN. For illustration, an example process for a signaling based application layer measurement will be described with reference to FIG. 3C.

FIG. 3C illustrates a schematic diagram illustrating another process 300C of communication for a signaling based application layer measurement according to embodiments of the present disclosure. For the purpose of discussion, the process 300C will be described with reference to FIG. 1. The process 300C may involve the terminal device 110, the network devices 120 and 130 and the AMF 141 as illustrated in FIG. 1. It is assumed that the terminal device 110 establishes a simultaneous connection with the network devices 120 and 130. The network device 120 serves as a MN and the network device 130 serves as a SN.

As shown in FIG. 3C, the AMF 141 may transmit 330, to the network device 120 (i.e., MN), application layer measurement information. In some embodiments, the application layer measurement information may comprise at least one of regular application layer measurement information or RAN visible application layer measurement information. In some embodiments, the RAN visible application layer measurement information may comprise RAN visible application layer measurement information for SN and RAN visible application layer measurement information for MN.

The network device 120 may transmit 331, to the network device 130 (i.e., SN), at least one of the following: the RAN visible application layer measurement information, an ID of the application layer measurement information for MN and SN, service type, area scope or slice scope. The network device 130 may generate a RAN visible application layer measurement configuration for SN and transmit 332 the RAN visible application layer measurement configuration for SN to the network device 120. In some embodiments, the network device 130 may provide, to the network device 120, the RAN visible application layer measurement configuration for SN and associated ID of the application layer measurement information. In some embodiments, the network device 130 may transmit the RAN visible application layer measurement configuration for SN and the associated ID of the application layer measurement information via a SN addition request acknowledgement message, a SN modification request acknowledgement message, a SN change required message or any other suitable messages.

The network device 120 may generate an application layer measurement configuration comprising at least one of the following: a regular application layer measurement configuration (also referred to as a set of configuration parameters herein), a RAN visible application layer measurement configuration for MN or the RAN visible application layer measurement configuration for SN. The network device 120 may transmit 333 the application layer measurement configuration to the terminal device 110.

The terminal device 110 may perform an application layer measurement based on the application layer measurement configuration and transmit 334 an application layer measurement report to the network device 120 (i.e., MN). In some embodiments, the application layer measurement report may comprise at least one of the following: a regular application layer measurement result (also referred to as a set of result parameters herein), a RAN visible application layer measurement result for MN and a RAN visible application layer measurement result for SN. In some embodiments, the RAN visible application layer measurement result for SN or MN may comprise cell ID information.

The network device 120 may forward 335 the RAN visible application layer measurement result for SN to the network device 130.

An example process for a management based application layer measurement will be described with reference to FIG. 3D. FIG. 3D illustrates a schematic diagram illustrating another process 300D of communication for a management based application layer measurement according to embodiments of the present disclosure. For the purpose of discussion, the process 300D will be described with reference to FIG. 1. The process 300D may involve the terminal device 110, the network devices 120 and 130 and the OAM 150 as illustrated in FIG. 1. It is assumed that the terminal device 110 establishes a simultaneous connection with the network devices 120 and 130. The network device 120 serves as a MN and the network device 130 serves as a SN.

As shown in FIG. 3D, the OAM 150 may transmit 340, to the network device 130, at least one of the following: RAN visible application layer measurement information, an application layer measurement reference, service type, area scope or slice scope.

The network device 130 may transmit 341, to the OAM 150, a RAN visible application layer measurement configuration for the network device 130 and corresponding application layer measurement reference.

The OAM 150 may transmit 342 application layer measurement information to the network device 120. The application layer measurement information may comprise at least one of the following: a regular application layer measurement information (also referred to as a set of parameters herein), information of a RAN visible application layer measurement for the network device 120 or the RAN visible application layer measurement configuration for the network device 130.

The network device 120 may transmit 343 an application layer measurement configuration to the terminal device 110. The application layer measurement configuration may comprise at least one of the following: a regular application layer measurement configuration (also referred to as a set of configuration parameters herein), a RAN visible application layer measurement configuration for the network device 120 or the RAN visible application layer measurement configuration for the network device 130.

The terminal device 110 may perform an application layer measurement based on the application layer measurement configuration and transmit 344 an application layer measurement report to the network device 120. In some embodiments, the application layer measurement report may comprise at least one of the following: a regular application layer measurement result (also referred to as a set of result parameters herein), a RAN visible application layer measurement result for the network device 120 and a RAN visible application layer measurement result for the network device 130. In some embodiments, the RAN visible application layer measurement result for the network device 120 or 130 may comprise cell ID information.

The network device 120 may forward 345 the RAN visible application layer measurement result for the network device 130 to the network device 130.

Another example process for a management based application layer measurement will be described with reference to FIG. 3E. FIG. 3E illustrates a schematic diagram illustrating another process 300E of communication for a management based application layer measurement according to embodiments of the present disclosure. For the purpose of discussion, the process 300E will be described with reference to FIG. 1. The process 300E may involve the terminal device 110, the network devices 120 and 130 and the OAM 150 as illustrated in FIG. 1. It is assumed that the terminal device 110 establishes a simultaneous connection with the network devices 120 and 130. The network device 120 serves as a MN and the network device 130 serves as a SN.

As shown in FIG. 3E, the OAM 150 may transmit 350, to the network device 120, an application layer measurement information comprising at least one of the following: regular application layer measurement information (also referred to as a set of parameters herein) or RAN visible application layer measurement information.

The OAM 150 may transmit 351, to the network device 130, at least one of the following: RAN visible application layer measurement information, an application layer measurement reference (also referred to as a measurement reference herein), service type, area scope or slice scope.

The network device 130 may transmit 352, to the network device 120, a RAN visible application layer measurement configuration for the network device 130 and corresponding application layer measurement reference. In some embodiments, the network device 130 may transmit the RAN visible application layer measurement configuration for the network device 130 and corresponding application layer measurement reference via a Xn setup request message, a Xn setup response message, a NG-RAN node configuration update message, a NG-RAN node configuration update acknowledge message or any other suitable messages.

The network device 120 may transmit 353 an application layer measurement configuration to the terminal device 110. The application layer measurement configuration may comprise at least one of the following: a regular application layer measurement configuration (also referred to as a set of configuration parameters herein), a RAN visible application layer measurement configuration for the network device 120 or the RAN visible application layer measurement configuration for the network device 130.

The terminal device 110 may perform an application layer measurement based on the application layer measurement configuration and transmit 354 an application layer measurement report to the network device 120. In some embodiments, the application layer measurement report may comprise at least one of the following: a regular application layer measurement result (also referred to as a set of result parameters herein), a RAN visible application layer measurement result for the network device 120 and a RAN visible application layer measurement result for the network device 130. In some embodiments, the RAN visible application layer measurement result for the network device 120 or 130 may comprise cell ID information.

The network device 120 may forward 355 the RAN visible application layer measurement result for the network device 130 to the network device 130.

In this way, mechanisms of configuring signaling based and management based application layer measurement in NR-DC scenarios are provided.

### EXAMPLE IMPLEMENTATION OF APPLICATION LAYER MEASUREMENT CONTINUITY

In mobility scenarios in NR-DC, it is still unclear how to forward application layer measurement configuration for SN during a handover (HO) procedure.

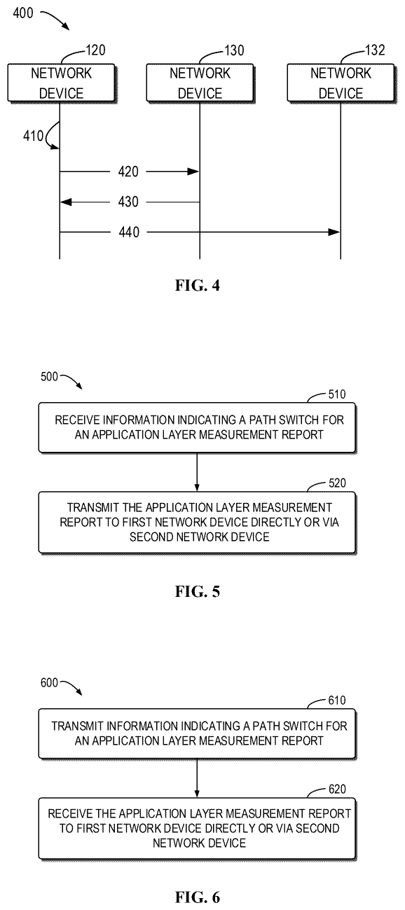

In view of this, embodiments of the present disclosure provide a solution to solve the above issue. The solution will be described with reference to FIG. 4.

FIG. 4 illustrates a schematic diagram illustrating a process 400 of communication for an application layer measurement configuration in mobility scenarios according to embodiments of the present disclosure. For the purpose of discussion, the process 400 will be described with reference to FIG. 1. The process 400 may involve the terminal device 110, the network devices 120, 130 and 132 as illustrated in FIG. 1. It is assumed that the terminal device 110 establishes a simultaneous connection with the network devices 120 and 130. The network device 120 serves as a MN and the network device 130 serves as a SN. The network device 120 serves as a source MN, and the network device 132 serves as a target MN.

As shown in FIG. 4, the network device 120 (i.e., source MN) may determine 410 whether the network device 120 has at least one of information of an application layer measurement for SN (i.e., the network device 130) or information of a RAN visible application layer measurement for SN.

If the network device 120 does not have the at least one of the information of an application layer measurement for SN or the information of a RAN visible application layer measurement for SN, the network device 120 may transmit 420 to the network device 130, a SN modification request message. The network device 130 may transmit 430, to the network device 120, the at least one of the information of the application layer measurement for SN or the information of the radio access network visible application layer measurement for SN, e.g., in a SN modification request acknowledgement message.

The network device 120 may transmit 440 a HO request message to the network device 132 (i.e., target MN). In some embodiments, the HO request message may comprises the at least one of the information of the application layer measurement for SN or the information of the RAN visible application layer measurement for SN.

In this way, a target MN may have application layer measurement information of SN and provide it to a target SN.

### EXAMPLE IMPLEMENTATION OF METHODS

Accordingly, embodiments of the present disclosure provide methods of communication implemented at a terminal device and a network device. These methods will be described below with reference to FIGS. 5 to 7.

In context of the present disclosure, a first network device may refer to a MN or SN, and the second network device may refer to a SN or MN. A third network device may refer to a network device having a similar functionality as AMF, and a fourth network device may refer to a network device having a similar functionality as OAM. A fifth network device may refer to a target MN.

FIG. 5 illustrates an example method 500 of communication implemented at a terminal device in accordance with some embodiments of the present disclosure. For example, the method 500 may be performed at the terminal device 110 as shown in FIG. 1. For the purpose of discussion, in the following, the method 500 will be described with reference to FIG. 1. It is to be understood that the method 500 may include additional blocks not shown and/or may omit some blocks as shown, and the scope of the present disclosure is not limited in this regard.

At block 510, the terminal device 110 receives, from a first network device (e.g., the network device 120), information indicating a path switch for an application layer measurement report.

At block 520, the terminal device 110 transmits, based on the information, the application layer measurement report to the network device 120 directly or via a second network device (e.g., the network device 130).

In some embodiments, the terminal device 110 may receive the information by at least one of the following: receiving a first indication for pausing the application layer measurement report; or receiving a second indication for changing a primary path to a cell group of the network device 130. In these embodiments, the terminal device 110 may transmit the application layer measurement report to the network device 120 via the network device 130.

In some embodiments, the terminal device 110 may transmit the application layer measurement report to the network device 120 via the network device 130 by at least one of the following: transmitting the application layer measurement report using a split SRB between the network device 120 and the terminal device 110; or transmitting the application layer measurement report using a SRB between the network device 130 and the terminal device 110.

In some embodiments, if the terminal device 110 is configured with a split SRB between the network device 120 and the terminal device 110 or a SRB between the network device 130 and the terminal device 110, the terminal device 110 may transmit the application layer measurement report to the network device 120 via the network device 130.

In some embodiments, if the terminal device 110 is configured with a split SRB between the network device 120 and the terminal device 110, the terminal device 110 may transmit the application layer measurement report via the split SRB. If the terminal device 110 is configured with no split SRB, the terminal device 110 may determine whether the terminal device 110 is configured with a SRB between the network device 130 and the terminal device 110. If the terminal device 110 is configured with the SRB between the network device 130 and the terminal device 110, the terminal device 110 may transmit the application layer measurement report via the SRB between the network device 130 and the terminal device 110.

In some embodiments, if the terminal device 110 is configured with no split SRB, and no SRB between the network device 130 and the terminal device 110, the terminal device 110 may suspend transmission of the application layer measurement report, and store the application layer measurement report.

In some embodiments, the split SRB may comprise at least one of the following: a split SRB1, a split SRB3, or a split SRB4.

In some embodiments, if packet duplication is configured or activated for a split SRB between the network device 120 and the terminal device 110, the terminal device 110 may submit, from a higher layer to a lower layer of the terminal device 110, the application layer measurement report and a third indication indicating that a packet corresponding to the application layer measurement report is submitted to only a RLC entity associated with the cell group of the network device 130.

In some embodiments, if no packet duplication is configured or activated for the split SRB and the primary path is set to a cell group of the network device 120, the terminal device 110 may submit, from a higher layer to a lower layer of the terminal device 110, the application layer measurement report and a fourth indication indicating that the packet corresponding to the application layer measurement report is submitted to the RLC entity associated with the cell group of the network device 130. Alternatively, the terminal device 110 may change the primary path to the cell group of the network device 130.

In some embodiments, the terminal device 110 may receive the information by at least one of the following: receiving a fifth indication for resuming the application layer measurement report; or receiving a sixth indication for changing the primary path to a cell group of the network device 110. In these embodiments, the terminal device 110 may transmit the application layer measurement report to the network device 120 directly.

In some embodiments, the terminal device 110 may perform at least one of the following: receiving, from the network device 120, a first configuration of a first application layer measurement report for the network device 120; receiving, from the network device 130, a second configuration of a second application layer measurement report for the network device 130; transmitting the first application layer measurement report to the network device 120; or transmitting the second application layer measurement report to the network device 130.

In some embodiments, the terminal device 110 may receive, from a MN, a configuration of an application layer measurement, the configuration comprising a set of configuration parameters, a RAN visible application layer measurement configuration for the MN and a RAN visible application layer measurement configuration for a SN. The terminal device 110 may transmit, to the MN, a report of the application layer measurement. the report may comprise a set of result parameters, a RAN visible application layer measurement result for the MN and a RAN visible application layer measurement result for the SN.

In some embodiments, the terminal device 110 may receive, from the network device 120, a configuration of an application layer measurement, the configuration comprising a set of configuration parameters, a RAN visible application layer measurement configuration for the network device 120 and a RAN visible application layer measurement configuration for the network device 130. The terminal device 110 may transmit, to the network device 120, a report of the application layer measurement. The report may comprise a set of result parameters, a RAN visible application layer measurement result for the network device 120 and a RAN visible application layer measurement result for the network device 130.

FIG. 6 illustrates an example method 600 of communication implemented at a first network device in accordance with some embodiments of the present disclosure. For example, the method 600 may be performed at the network device 120, 130 or 132 as shown in FIG. 1. For the purpose of discussion, in the following, the method 600 will be described with reference to FIG. 1. It is to be understood that the method 600 may include additional blocks not shown and/or may omit some blocks as shown, and the scope of the present disclosure is not limited in this regard.

As shown in FIG. 6, at block 610, a first network device (e.g., the network device 120) transmits, to the terminal device 110, information indicating a path switch for an application layer measurement report.

At block 620, the network device 120 receives, from the terminal device 110, the application layer measurement report directly or via a second network device (e.g., the network device 130).

In some embodiments, the network device 120 may transmit the information by at least one of the following: transmitting a first indication for pausing the application layer measurement report; or transmitting a second indication for changing a primary path to a cell group of the second network device. In these embodiments, the network device 120 may receive the application layer measurement report via the network device 130.

In some embodiments, the network device 120 may transmit the information by at least one of the following: transmitting a third indication for resuming the application layer measurement report; or transmitting a fourth indication for changing the primary path to a cell group of the first network device. In these embodiments, the network device 120 may receive the application layer measurement report from the terminal device 110 directly.

In some embodiments, the network device 120 may perform at least one of the following: receiving, from a third network device (e.g., AMF 141), first information of an application layer measurement for the network device 120; transmitting, to the terminal device 110, a first configuration of a first application layer measurement report for the network device 120; or receiving the first application layer measurement report from the terminal device 110.

In some embodiments, the network device 120 may receive, from the AMF 141, second information of an application layer measurement for the network device 130, and transmit the second information to the network device 130.

In some embodiments, the network device 120 may perform at least one of the following: receiving, from the AMF 141, information of an application layer measurement and information of a RAN visible application layer measurement; transmitting, to the network device 130, at least one of the information of the RAN visible application layer measurement, an identity of an application layer measurement configuration for the network device 120, service type, area scope or slice scope; receiving, from the network device 130, a RAN visible application layer measurement configuration for the network device 130; transmitting, to the terminal device 110, a configuration of an application layer measurement, the configuration comprising a set of configuration parameters, the RAN visible application layer measurement configuration for the network device 120 and the RAN visible application layer measurement configuration for the network device 130; receiving, from the terminal device 110, a report of the application layer measurement, the report comprising a set of result parameters, a RAN visible application layer measurement result for the network device 120 and a RAN visible application layer measurement result for the network device 130; or transmitting, to the network device 130, the RAN visible application layer measurement result for the network device 130.

In some embodiments, the network device 120 may perform at least one of the following: receiving, from a fourth network device (e.g., OAM 150), information of an application layer measurement comprising at least one of a set of parameters, information of a RAN visible application layer measurement for the network device 120 or a RAN visible application layer measurement configuration for the network device 130; transmitting, to the terminal device 110, a configuration of an application layer measurement, the configuration comprising a set of configuration parameters, the RAN visible application layer measurement configuration for the network device 120 and the RAN visible application layer measurement configuration for the network device 130; receiving, from the terminal device 110, a report of the application layer measurement, the report comprising a set of result parameters, a RAN visible application layer measurement result for the network device 120 and a RAN visible application layer measurement result for the network device 130; or transmitting, to the network device 130, the RAN visible application layer measurement result for the network device 130.

In some embodiments, the network device 120 may perform at least one of the following: receiving, from a fourth network device (e.g., OAM 150), information of an application layer measurement comprising at least one of a set of configuration parameters or information of a RAN visible application layer measurement; receiving, from the network device 130, a RAN visible application layer measurement configuration for the network device 130 and a measurement reference; transmitting, to the terminal device 110, a configuration of an application layer measurement, the configuration comprising a set of configuration parameters, the RAN visible application layer measurement configuration for the network device 120 and the RAN visible application layer measurement configuration for the network device 130; receiving, from the terminal device 110, a report of the application layer measurement, the report comprising a set of result parameters, a RAN visible application layer measurement result for the network device 120 and a RAN visible application layer measurement result for the network device 130; or transmitting, to the network device 130, the RAN visible application layer measurement result for the network device 130.

In some embodiments, the network device 120 may perform at least one of the following: transmitting a HO request message to a fifth network device (e.g., network device 132), the HO request message comprising at least one of information of an application layer measurement for the network device 130 or information of a RAN visible application layer measurement for the network device 130; if the network device 120 does not have the at least one of the information of the application layer measurement for the network device 130 or the information of the RAN visible application layer measurement for the network device 130, transmitting, to the network device 130, a SN modification request; or receiving, from the network device 130, the at least one of the information of the application layer measurement for the network device 130 or the information of the RAN visible application layer measurement for the network device 130.

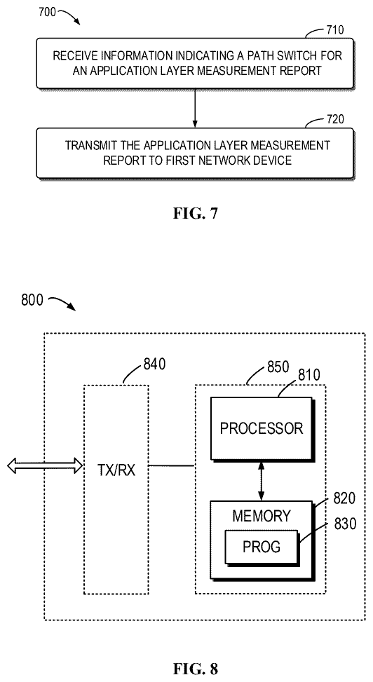

FIG. 7 illustrates an example method 700 of communication implemented at a second network device in accordance with some embodiments of the present disclosure. For example, the method 700 may be performed at the network device 120, 130 or 132 as shown in FIG. 1. For the purpose of discussion, in the following, the method 700 will be described with reference to FIG. 1. It is to be understood that the method 700 may include additional blocks not shown and/or may omit some blocks as shown, and the scope of the present disclosure is not limited in this regard.

As shown in FIG. 7, at block 710, a second network device (e.g., the network device 130) receives, from the terminal device 110, an application layer measurement report.

At block 720, the network device 130 transmits the application layer measurement report to a first network device (e.g., the network device 120).

In some embodiments, the network device 130 may perform at least one of the following: receiving, from the network device 120 or a third network device (e.g., AMF 141), second information of an application layer measurement for the network device 130; transmitting, to the terminal device 110, a second configuration of a second application layer measurement report for the network device 130; or receiving the second application layer measurement report from the terminal device 110.

In some embodiments, the network device 130 may perform at least one of the following: receiving, from the network device 120, at least one of the information of the RAN visible application layer measurement, an identity of a RAN visible application layer measurement configuration for the network device 120, service type, area scope or slice scope; transmitting, to the network device 120, a RAN visible application layer measurement configuration for the network device 130; or receiving, from the network device 120, a RAN visible application layer measurement result for the network device 130.

In some embodiments, the network device 130 may perform at least one of the following: receiving, from a fourth network device (e.g., the OAM 150), at least one of information of a RAN visible application layer measurement, a measurement reference, service type, area scope or slice scope; transmitting, to the OAM 150, a RAN visible application layer measurement configuration for the network device 130 and the measurement reference; or receiving, from the network device 120, a RAN visible application layer measurement result for the network device 130.

In some embodiments, the network device 130 may perform at least one of the following: receiving, from the OAM 150, at least one of information of a RAN visible application layer measurement, a measurement reference, service type, area scope or slice scope; transmitting, to the network device 120, a RAN visible application layer measurement configuration for the network device 130 and a measurement reference; or receiving, from the network device 120, a RAN visible application layer measurement result for the network device 130.

In some embodiments, the network device 130 may perform at least one of the following: receiving, from the network device 120, a SN modification request; or transmitting, to the network device 120, at least one of information of an application layer measurement for the network device 130 or information of a RAN visible application layer measurement for the network device 130.

In some embodiments, the network device 120 is a MN, and the network device 130 is a SN. In some embodiments, the network device 120 is a SN, and the network device 130 is a MN.

It is to be understood that the operations of methods 500 to 700 are similar as that described in connection with FIGS. 2 to 3E, and thus other details are not repeated here for concise.

### EXAMPLE IMPLEMENTATION OF DEVICES AND APPARATUSES

FIG. 8 is a simplified block diagram of a device 800 that is suitable for implementing embodiments of the present disclosure. The device 800 can be considered as a further example implementation of the terminal device 110 or the network device 120 or the network device 130 or the network device 132 or the AMF 141 or the OAM 150 as shown in FIG. 1. Accordingly, the device 800 can be implemented at or as at least a part of the terminal device 110 or the network device 120 or the network device 130 or the network device 132 or the AMF 141 or the OAM 150.

As shown, the device 800 includes a processor 810, a memory 820 coupled to the processor 810, a suitable transmitter (TX) and receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 830 is assumed to include program instructions that, when executed by the associated processor 810, enable the device 800 to operate in accordance with the embodiments of the present disclosure, as discussed herein with reference to FIGS. 1 to 7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

In some embodiments, a terminal device comprises a circuitry configured to: receive, from a first network device, information indicating a path switch for an application layer measurement report; and transmit, based on the information, the application layer measurement report to the first network device directly or via a second network device.

In some embodiments, a first network device comprises a circuitry configured to: transmit, to a terminal device, information indicating a path switch for an application layer measurement report; and receive, from the terminal device, the application layer measurement report directly or via a second network device.

In some embodiments, a second network device comprises a circuitry configured to: receive, from a terminal device, an application layer measurement report; and transmit the application layer measurement report to a first network device.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure may provide the following solutions.

In one solution, a method of communication comprises: receiving, at a terminal device and from a first network device, information indicating a path switch for an application layer measurement report; and transmitting, based on the information, the application layer measurement report to the first network device directly or via a second network device.

In some embodiments, receiving the information comprises at least one of the following: receiving a first indication for pausing the application layer measurement report; or receiving a second indication for changing a primary path to a cell group of the second network device. In these embodiments, transmitting the application layer measurement report comprises transmitting the application layer measurement report to the first network device via the second network device.

In some embodiments, transmitting the application layer measurement report to the first network device via the second network device comprises at least one of the following: transmitting the application layer measurement report using a split signaling radio bearer between the first network device and the terminal device; or transmitting the application layer measurement report using a signaling radio bearer between the second network device and the terminal device.

In some embodiments, transmitting the application layer measurement report to the first network device via the second network device comprises: in accordance with a determination that the terminal device is configured with a split signaling radio bearer between the first network device and the terminal device or a signaling radio bearer between the second network device and the terminal device, transmitting the application layer measurement report to the first network device via the second network device.

In some embodiments, transmitting the application layer measurement report to the first network device via the second network device comprises: in accordance with a determination that the terminal device is configured with a split signaling radio bearer between the first network device and the terminal device, transmitting the application layer measurement report via the split signaling radio bearer; in accordance with a determination that the terminal device is configured with no split signaling radio bearer, determining whether the terminal device is configured with a signaling radio bearer between the second network device and the terminal device; and in accordance with a determination that the terminal device is configured with the signaling radio bearer between the second network device and the terminal device, transmitting the application layer measurement report via the signaling radio bearer between the second network device and the terminal device.

In some embodiments, the method above further comprises: in accordance with a determination that the terminal device is configured with no split signaling radio bearer and no signaling radio bearer between the second network device and the terminal device, suspending transmission of the application layer measurement report; and storing the application layer measurement report.

In some embodiments, the split signaling radio bearer comprises at least one of the following: a split signaling radio bearer 1, a split signaling radio bearer 3, or a split signaling radio bearer 4.

In some embodiments, transmitting the application layer measurement report to the first network device via the second network device comprises: in accordance with a determination that packet duplication is configured or activated for a split signaling radio bearer between the first network device and the terminal device, submitting, from a higher layer to a lower layer of the terminal device, the application layer measurement report and a third indication indicating that a packet corresponding to the application layer measurement report is submitted to only a radio link control entity associated with the cell group of the second network device; or in accordance with a determination that no packet duplication is configured or activated for the split signaling radio bearer and the primary path is set to a cell group of the first network device, submitting, from a higher layer to a lower layer of the terminal device, the application layer measurement report and a fourth indication indicating that the packet corresponding to the application layer measurement report is submitted to the radio link control entity associated with the cell group of the second network device; or changing the primary path to the cell group of the second network device.

In some embodiments, receiving the information comprises at least one of the following: receiving a fifth indication for resuming the application layer measurement report; or receiving a sixth indication for changing the primary path to a cell group of the first network device. In these embodiments, transmitting the application layer measurement report comprises transmitting the application layer measurement report to the first network device directly.

In some embodiments, the method above further comprises at least one of the following: receiving, from the first network device, a first configuration of a first application layer measurement report for the first network device; receiving, from the second network device, a second configuration of a second application layer measurement report for the second network device; transmitting the first application layer measurement report to the first network device; or transmitting the second application layer measurement report to the second network device.

In some embodiments, the method above further comprises: receiving, from a master node, a configuration of an application layer measurement, the configuration comprising a set of configuration parameters, a radio access network visible application layer measurement configuration for the master node and a radio access network visible application layer measurement configuration for a secondary node; and transmitting, to the master node, a report of the application layer measurement, the report comprising a set of result parameters, a radio access network visible application layer measurement result for the master node and a radio access network visible application layer measurement result for the secondary node.

In some embodiments, the method above further comprises: receiving, from the first network device, a configuration of an application layer measurement, the configuration comprising a set of configuration parameters, a radio access network visible application layer measurement configuration for the first network device and a radio access network visible application layer measurement configuration for the second network device; and transmitting, to the first network device, a report of the application layer measurement, the report comprising a set of result parameters, a radio access network visible application layer measurement result for the first network device and a radio access network visible application layer measurement result for the second network device.

In another solution, a method of communication comprises: transmitting, at a first network device and to a terminal device, information indicating a path switch for an application layer measurement report; and receiving, from the terminal device, the application layer measurement report directly or via a second network device.

In some embodiments, transmitting the information comprises at least one of the following: transmitting a first indication for pausing the application layer measurement report; or transmitting a second indication for changing a primary path to a cell group of the second network device. In these embodiments, receiving the application layer measurement report comprises receiving the application layer measurement report via the second network device.

In some embodiments, transmitting the information comprises at least one of the following: transmitting a third indication for resuming the application layer measurement report; or transmitting a fourth indication for changing the primary path to a cell group of the first network device. In these embodiments, receiving the application layer measurement report comprises receiving the application layer measurement report from the terminal device directly.

In some embodiments, the method above further comprises at least one of the following: receiving, from a third network device, first information of an application layer measurement for the first network device; transmitting, to the terminal device, a first configuration of a first application layer measurement report for the first network device; or receiving the first application layer measurement report from the terminal device.

In some embodiments, the method above further comprises: receiving, from the third network device, second information of an application layer measurement for the second network device; and transmitting the second information to the second network device.

In some embodiments, the method above further comprises at least one of the following: receiving, from a third network device, information of an application layer measurement and information of a radio access network visible application layer measurement; transmitting, to the second network device, at least one of the information of the radio access network visible application layer measurement, an identity of an application layer measurement configuration for the first network device, service type, area scope or slice scope; receiving, from the second network device, a radio access network visible application layer measurement configuration for the second network device; transmitting, to the terminal device, a configuration of an application layer measurement, the configuration comprising a set of configuration parameters, the radio access network visible application layer measurement configuration for the first network device and the radio access network visible application layer measurement configuration for the second network device; receiving, from the terminal device, a report of the application layer measurement, the report comprising a set of result parameters, a radio access network visible application layer measurement result for the first network device and a radio access network visible application layer measurement result for the second network device; or transmitting, to the second network device, the radio access network visible application layer measurement result for the second network device.

In some embodiments, the method above further comprises at least one of the following: receiving, from a fourth network device, information of an application layer measurement comprising at least one of a set of parameters, information of a radio access network visible application layer measurement for the first network device or a radio access network visible application layer measurement configuration for the second network device; transmitting, to the terminal device, a configuration of an application layer measurement, the configuration comprising a set of configuration parameters, the radio access network visible application layer measurement configuration for the first network device and the radio access network visible application layer measurement configuration for the second network device; receiving, from the terminal device, a report of the application layer measurement, the report comprising a set of result parameters, a radio access network visible application layer measurement result for the first network device and a radio access network visible application layer measurement result for the second network device; or transmitting, to the second network device, the radio access network visible application layer measurement result for the second network device.

In some embodiments, the method above further comprises at least one of the following: receiving, from a fourth network device, information of an application layer measurement comprising at least one of a set of configuration parameters or information of a radio access network visible application layer measurement; receiving, from the second network device, a radio access network visible application layer measurement configuration for the second network device and a measurement reference; transmitting, to the terminal device, a configuration of an application layer measurement, the configuration comprising a set of configuration parameters, the radio access network visible application layer measurement configuration for the first network device and the radio access network visible application layer measurement configuration for the second network device; receiving, from the terminal device, a report of the application layer measurement, the report comprising a set of result parameters, a radio access network visible application layer measurement result for the first network device and a radio access network visible application layer measurement result for the second network device; or transmitting, to the second network device, the radio access network visible application layer measurement result for the second network device.

In some embodiments, the method above further comprises at least one of the following: transmitting a handover request message to a fifth network device, the handover request message comprising at least one of information of an application layer measurement for the second network device or information of a radio access network visible application layer measurement for the second network device; in accordance with a determination that the first network device does not have the at least one of the information of the application layer measurement for the second network device or the information of the radio access network visible application layer measurement for the second network device, transmitting, to the second network device, a secondary node modification request; or receiving, from the second network device, the at least one of the information of the application layer measurement for the second network device or the information of the radio access network visible application layer measurement for the second network device.

In another solution, a method of communication comprises: receiving, at a second network device and from a terminal device, an application layer measurement report; and transmitting the application layer measurement report to a first network device.

In some embodiments, the method above further comprises at least one of the following: receiving, from the first network device or a third network device, second information of an application layer measurement for the second network device; transmitting, to the terminal device, a second configuration of a second application layer measurement report for the second network device; or receiving the second application layer measurement report from the terminal device.

In some embodiments, the method above further comprises at least one of the following: receiving, from the first network device, at least one of the information of the radio access network visible application layer measurement, an identity of a radio access network visible application layer measurement configuration for the first network device, service type, area scope or slice scope; transmitting, to the first network device, a radio access network visible application layer measurement configuration for the second network device; or receiving, from the first network device, a radio access network visible application layer measurement result for the second network device.

In some embodiments, the method above further comprises at least one of the following: receiving, from a fourth network device, at least one of information of a radio access network visible application layer measurement, a measurement reference, service type, area scope or slice scope; transmitting, to the fourth network device, a radio access network visible application layer measurement configuration for the second network device and the measurement reference; or receiving, from the first network device, a radio access network visible application layer measurement result for the second network device.

In some embodiments, the method above further comprises at least one of the following: receiving, from a fourth network device, at least one of information of a radio access network visible application layer measurement, a measurement reference, service type, area scope or slice scope; transmitting, to the first network device, a radio access network visible application layer measurement configuration for the second network device and a measurement reference; or receiving, from the first network device, a radio access network visible application layer measurement result for the second network device.

In some embodiments, the method above further comprises at least one of the following: receiving, from the first network device, a secondary node modification request; or transmitting, to the first network device, at least one of information of an application layer measurement for the second network device or information of a radio access network visible application layer measurement for the second network device.

In some embodiments, the first network device is a master node, and the second network device is a secondary node. In some embodiments, the first network device is a secondary node, and the second network device is a master node.

In another solution, a device of communication comprises a processor configured to cause the device to perform the method according to any of the claims above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method of a User Equipment (UE) in Dual Connectivity (DC), the method comprising:
receiving, from a Secondary Node (SN), information indicating that the SN receives an application layer measurement report from the UE directly or the SN receives the application layer measurement report from the UE via a Master Node (MN); and
sending, based on the information, the application layer measurement report, to the SN directly or to the SN via the MN.

22. The method according to claim 21, wherein a Signaling Radio Bearer 4 (SRB4) is used to send the application layer measurement report to the SN via the MN.

23. The method according to claim 22, wherein the DC is New Radio DC (NR-DC), the MN is a next generation Node B (gNB) and the SN is a gNB.

24. A User Equipment (UE) in Dual Connectivity (DC), the UE comprising:
at least one processor; and
at least one memory coupled to the at least one processor, the at least one memory storing instructions that, if executed by the at least one processor, cause the at least one processor to:
receive, from a Secondary Node (SN), information indicating that the SN receives an application layer measurement report from the UE directly or the SN receives the application layer measurement report from the UE via a Master Node (MN); and
send, based on the information, the application layer measurement report, to the SN directly or to the SN via the MN.

25. The UE according to claim 24, wherein a Signaling Radio Bearer 4 (SRB4) is used to send the application layer measurement report to the SN via the MN.

26. The UE according to claim 25, wherein the DC is New Radio DC (NR-DC), the MN is a next generation Node B (gNB) and the SN is a gNB.

27. A method of a Secondary Node (SN) in Dual Connectivity (DC), the method comprising:
sending, to a User Equipment (UE), information indicating that the SN receives an application layer measurement report from the UE directly or the SN receives the application layer measurement report from the UE via a Master Node (MN); and
receiving the application layer measurement report, from the UE directly or from the UE via the MN, based on the information.

28. The method according to claim 27, wherein a Signaling Radio Bearer 4 (SRB4) is used to receive the application layer measurement report from the UE via the MN.

29. The method according to claim 28, wherein the DC is New Radio DC (NR-DC), the MN is a next generation Node B (gNB) and the SN is a gNB.
